(19) United States
(12) Patent Application Publication
(10) Pub. No.: US 2007/0195963 A1
(43) Pub. Date: Aug. 23, 2007

(54) Measuring ear biometrics for sound optimization

(75) Inventors: Raymond Ko, Burnaby (CA); Ed Jordan, Burnaby (CA)

Correspondence Address: Ware, Fressola, Van Der Sluys & Adolphson, LLP;Building Five, Bradford Green 755 Main Street, P.O. Box 224, Monroe, CT, 06468, US

(73) Assignee: Nokia Corporation

(21) Appl. No.: 11/359,963

(22) Filed: Feb. 21, 2006

(51) Int. Cl. H04R 5/00; H04R 5/02

(52) U.S. Cl. 381/26; 381/309

(57) ABSTRACT

Adjusting sound using biometrical information is provided by measuring a response of a human's ear to a test signal, comparing the measured response with a target response, obtaining deviations between the measured response and the target response, and adjusting sound using the obtained deviations.

### TECHNICAL FIELD

The present patent application relates to measuring ear biometrics for sound optimization based on the measured biometrics.

### BACKGROUND OF THE INVENTION

It is known in the art that the human biometrics vary. It is known that biometrics may be obtained from fingerprints, face recognition, iris-scan, ear scan, etc. The ear biometrics may comprise the size and form of the ear, or even a frequency response of the ear.

When designing loudspeakers and equalizers, it is commonly accepted that a test sound is tested with a “Reference Ear”. “Reference Ear” in this case may refer to i) a standardized equipment setup and methodology for the objective measurement and description of an acoustic signal, or ii) a listener who has “golden ears” and judges the sound subjectively. The frequency spectrum within the reference ear is measured and the loudspeakers and equalizers are adjusted so that the measured sound matches best with the test sound. However, not all humans have ears like the reference ear. Thus, there are variances in the perceived sound when compared to the reference design. The hearing experience of a user can be influenced by many factors. For example, age, ear wax, health, ear drum damage, outer and inner ear dimensions, etc. can account for different hearing experiences of one single sound. Different people may have different hearing experiences. It may also happen, that one single person may have different hearing experiences at different times due to the a.m. reasons.

The hearing experience may also be influenced by the position of the sound source, the electroacoustic transfer function of the middle and inner ear of a user, and the way the brain interprets a sound signal sent from the cochlea along the 8^{th} nerve. In particular, the user's outer ear dimension may have a significant impact on the way a sound is perceived.

In common consumer electronic devices, a sound equalization is provided using tone controls and graphic equalizers. A device can be adjusted using these means to provide for a “natural”, and “balanced” hearing experience. However, most users do not know how to control these means to obtain an optimum audio quality. For this reasons, commonly known devices provide for pre-set equalizers. For example, equalizers for “Pop”, and “Rock” may be provided. Users have the tendency to arbitrarily audition presets in series, selecting the first one which makes the audio experience “bearable”. Nevertheless, all of the known tone controls of consumer electronic devices lack resolution and preciseness. Further, these solutions lack personalization at all. The devices cannot adjust the sound to individual hearing capabilities. This may cause the effect that some users tend to increase the volume above a normal level to hear a “better” sound. This will cause ear damage and has to be avoided.

In the field of mobile telephony, international standardization specifies the appropriate frequency responses and test methods for mobile voice telephony. For type approval exercises and similar certifications, the frequency response is measured with a handset connected to an acoustic coupler containing a measurement microphone. The couplers may be formed as “ear simulators” and are becoming increasingly more realistic in their simulation of an “average” human ear. However, any standardized test remains an indication of the devices performance under a single unique set of conditions. Nevertheless, in a real world situation, users will hold and position a handset in many different ways against the ear. This results in the frequency response being different each time, even for two users with similar hearing.

### SUMMARY OF THE INVENTION

Therefore, it is an object of the present patent application to provide increased hearing experience taking real live conditions into account. It is another object of the present patent application to provide individually adjusted sound. Another object of the present patent application is to account for ear biometrics for sound adjustment.

These and other objects are solved, according to one aspect of the present patent application, by a method for adjusting sound with measuring a response of a human's ear to a test signal, comparing the measured response with a target response, obtaining deviations between the measured response and the target response, and adjusting sound using the obtained deviations.

The present patent application thus provides means for providing a personalized, unique audio device. The patent application provides for tuning sound individually for a person's hearing in real time. It is provided that the device which is responsible for playing back the sound measures by itself the response, i.e. the frequency response of the user's ear, i.e. the outer ear and ear canal. The device may then use this information to tune the audio playback such that the tonal balance is uniquely matched to the user's hearing. This provides for improved audio quality for music playback and improved intelligibility for voice telephony.

The present patent application provides for automated fine-tuning of acoustics/music listening experience so that the perceived sound for each human individual is close to the intended reference design. Personalizing music/audio listening experience to each of the two ears is possible according to embodiments.

Embodiments of the present patent application provide for an enhanced music listening experience. Users are enabled to hear a true, natural sound. A user device may automatically adjust the tonal balance to match the user's hearing capabilities. Environmental parameters may be taken into account and the target response may account for the environmental parameters.

Another aspect of the present patent application is a unit, an electronic device, and a mobile multimedia device for adjusting sound comprising a test signal generator for generating a test signal a response signal sensor arranged for measuring a response of a human's ear to the test signal, a comparator arranged for comparing the measured response with a target response, and for obtaining deviations between the measured response and the target response, and an adjusting unit arranged for adjusting sound using the obtained deviations. The unit or electronic device may be an accessory of any multimedia or sound device.

A mobile multimedia device may comprise appliances for mobile music playback, radio, podcasts, internet radio, satellite radio, gaming consoles, mobile television, mobile browsing etc.

Another aspect of the present patent application is a software program product, in which a software code for adjusting sound is stored, said software code realizing the following steps when being executed by a processing unit of an electronic device measuring a response of a human's ear to a test signal, comparing the measured response with a target response, obtaining deviations between the measured response and the target response, and adjusting sound using the obtained deviations.

Further aspects and advantages can be derived from the drawings.

### BRIEF DESCRIPTION OF THE DRAWINGS

In the drawings show:

FIG. 1 a first mobile device according to embodiments;

FIG. 2 a further mobile device according to embodiments;

FIG. 3 a flowchart of a method according to embodiments.

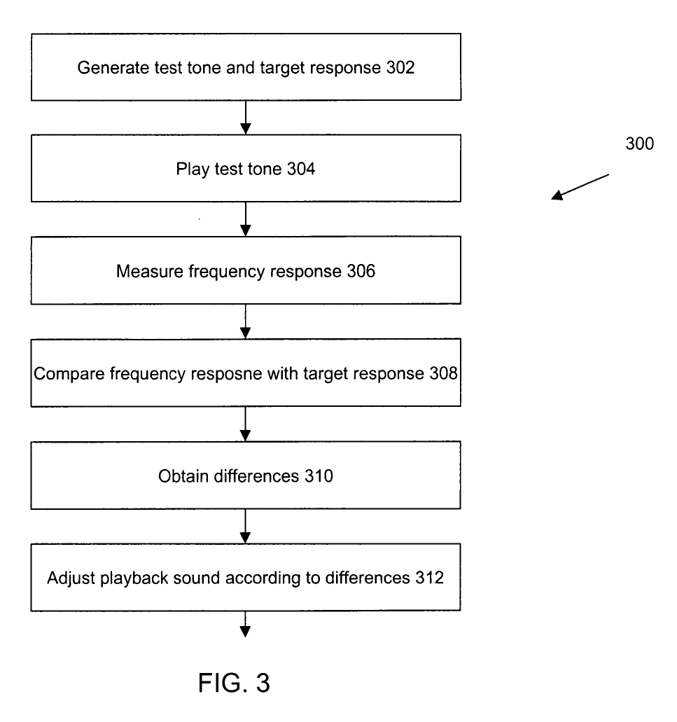

### DETAILED DESCRIPTION OF THE DRAWINGS

The ear cochlea contains the sensory organ of hearing. It has also been found that the dimensions of a persons outer ear—which includes the pinna, the concha, and the ear canal—has a significant influence upon the frequency response of a person's hearing. It will affect the tonal balance of everything a person hears. Because everybody's tonal perception is unique, it is impossible to produce a single set of criteria for sound reproduction which will please everybody. If some recorded music were played to a sample of listeners, the same sound might be described as bright, dull, boxy or well balanced by different people.

Frequency response may be understood as the measure of a system's response at the output to a signal of preferably varying frequency and preferably constant amplitude at its input. The frequency response may be characterized by the magnitude of the system's response, measured in dB, and the phase, measured in radians, versus frequency. The frequency response of a system can be measured by applying an impulse to the system and measuring its response, sweeping a constant-amplitude pure tone through the bandwidth of interest and measuring the output level and phase shift relative to the input, or applying a maximum length sequence. The frequency response may also be considered as transfer function of a system.

Once a frequency response has been measured, and assuming the system is linear and time-invariant, its characteristic can be approximated with arbitrary accuracy by a digital filter. Similarly, if a system is demonstrated to have a certain frequency response, a real time filtering (digital or analog) can be applied to the signals prior to their reproduction to compensate for these deficiencies.

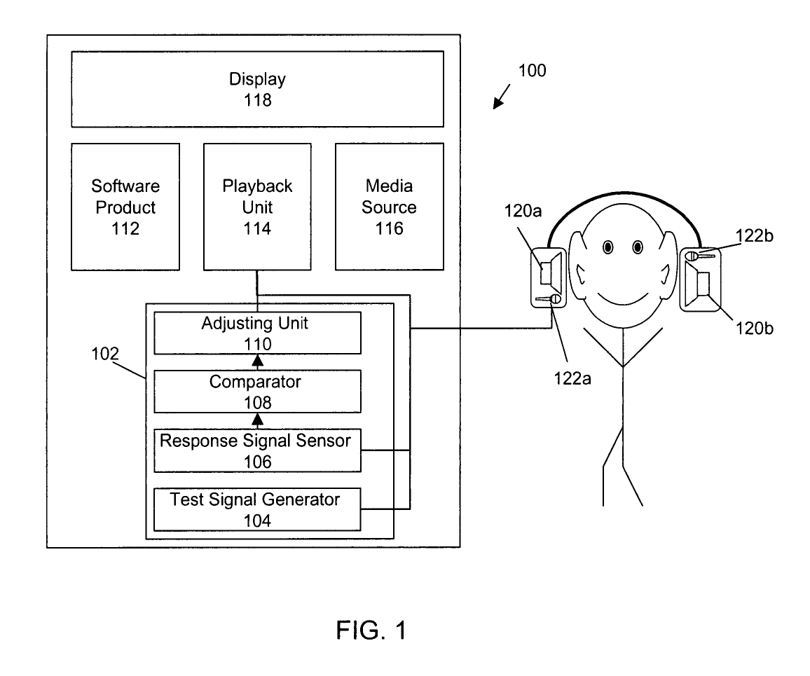

In order to overcome these defects, embodiments provide a device as illustrated in FIG. 1.

FIG. 1 illustrates a mobile multimedia device 100 with a unit 102 for adjusting sound. The unit 102 comprises a test signal generator 104 for generating a test signal, a response signal sensor 106 arranged for measuring a response of a human's ear to the test signal, a comparator arranged 108 for comparing the measured response with a target response, and for obtaining deviations between the measured response and the target response, and an adjusting unit 110 arranged for adjusting sound using the obtained deviations.

Further, the device 102 comprises a playback unit 114, a media source 116 and a display 118. The device 102 can be operated by a software program stored on a software program product 112. Interoperation between the elements of the devices is possible without reference to the lines and arrows in the Figure.

The device 102 further comprises a headphone with loudspeakers 120 and microphones 122. The loudspeaker 120 may be considered as part of the test signal generator 104. The microphones 122 may be considered part of the response signal sensor 104. The microphones 122 are arranged for receiving the human's ear response to the test signal.

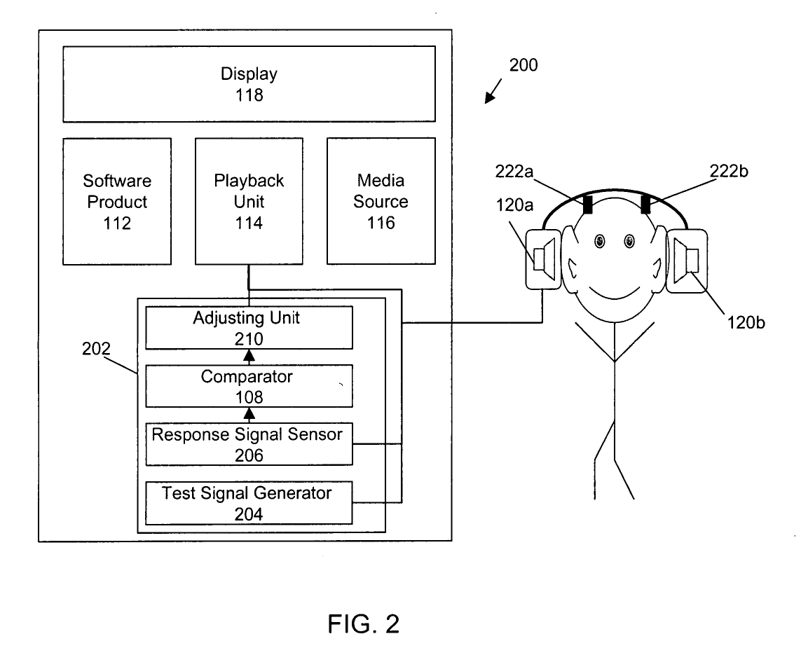

FIG. 2 illustrated a device 200 having in general the same features as the device in FIG. 1. Different to FIG. 1, the device 200 comprises a test signal generator 204 and a response signal sensor 206 which are capable of performing an auditory brainstem response (ABR) measurement. In order to record the brain response, for example on the cochlea along the 8^{th} nerve, sensors 222 are provided.

The operation 300 of the device 100 and the device 200 will be explained in more detail below.

A test tone and a target response may be generated 302 in test signal generator 104. The test tone may be generated according to the implemented response measurement. In case a frequency response is measured, the test tone may be a reference tone, a burst of white noise, a maximum length sequence (MLS), a pulse, or a pink noise (which is white noise filtered through a filter). Derivatives of these named test tones may also be used. Derivatives may be understood as test tones, which initially are created as the named test tones but are tailored for certain needs, i.e. filtered through tailored filters prior to being used for testing. The frequency range may be between 20 Hz to 20 kHz. The test tone may also be in the frequency range between 500 Hz and 4 kHz. The test tone may also comprise sounds, which are characterized by pitch, loudness, and/or timbre.

In case an ABR measurement is done the test tone may be a stimulus at an intensity level of 30-40 dB and created in test signal generator 204.

In test signal generator 104, 204, a test tone and a target response may also be generated based on a target type of sound, or a target type of environment. For example, different types of sound, i.e. voice, pop music, rock music, jazz, discussions, television, concerts and the like may require slightly different response parameters to account for improved hearing experience. Therefore, for a certain type of sound, a special target response may also be created. The target response may be designed for maximum speech intelligibility, or alternatively for optimum audio quality during music playback.

The test tone and the target response may also be already stored in a database and be retrieved upon actual need. The test tone and the target response may be stored in media source 116. The frequency spectrum of the test tone, which may also be a digital signal, may also be already stored in a DSP (not shown) in the device 100, 200. The spectrum may be found by performing a “Fast Fourier Transformation” (FFT) on the test tone to translate the data to the frequency domain.

After having created 302 the test tone and the target response, the test tone is played back in loudspeakers 120. For example, a user may hold a mobile phone to his ear. This position may be the same as when making a phone call. The earpiece would then be the loudspeaker 120 and be used to playback the reference tone. Any unwanted equalization due to the earpiece would be compensated for, for example within DSP filtering during creation of the test tone, to produce a neutral response.

The sound produced by the loudspeaker 122 would cause the ear and the ear canal to resonate. The dimensions of the ear and ear canal determine the frequency response and resonant frequencies.

The microphones 122, positioned close to the loudspeaker 120 monitor the response. In case of ABR, the sensors 222 would monitor signals on the 8^{th} nerve in response to the stimulus.

The received sound is transferred from the microphones 122 to the response signal sensor 106. In case of ABR, the sensed signal is transferred to the response signal sensor 206.

Within response signal sensor 106, a FFT processes this sensed signal to obtain 306 the frequency response of each of the individual's ears. For each ear, a frequency response is obtained 306.

The obtained 306 frequency response is compared 308 in comparator 108 with the target frequency response. By comparing 308 the frequency response with the target frequency response, differences may be obtained 310. In case measured response is useless, i.e. corrupted, or in case no evaluable response can be measured, a default value, an interpolated value, and/or an extrapolated value can be used instead.

With the obtained 310 difference, the correct frequency response equalization for the audio signal can be calculated. Any required audio signal could then be digitally filtered in real-time according to this equalization. A deviation from the target frequency response by the frequency response may be accounted for by amplifying or attenuating certain frequencies, where a difference occurred.

In adjusting unit 110, the amplifying or attenuating of the frequencies can be tuned. With these parameters, playback sound can be adjusted 312. Adjusting unit 110 can comprise a tone controller, an equalizer, a pitch resolution controller, a loudness controller, and a quality or timbre controller. The adjustment can account for controlling a pitch resolution to enable recognition of absolute pitches, controlling loudness for equal loudness curves (equal loudness contour), or controlling quality or timbre to enable recognition of harmonic content, attack, decay, and vibrato of a musical instruments or human voice. It may also be possible to factor background noise to improve audio listening.

For example, within media source 116, a video is stored. For video applications, a certain target frequency response has been used. With the obtained frequency response, the parameters for adjusting unit 110 are set. The playback of sound in the video is enhanced be means of the adjusting unit 110 according to the set parameters. Users hear the sound with an improved equalization. The corresponding video may be displayed on display 118. The media source 116 may also be a television receiver, a mobile phone receiver, a gaming device, etc.

While there have been shown and described and pointed out fundamental novel features of the invention as applied to a preferred embodiment thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto. It should also be recognized that any reference signs shall not be constructed as limiting the scope of the claims.

What is claimed is:

1. A method for adjusting sound with:
measuring a response of a human's ear to a test signal,
comparing the measured response with a target response,
obtaining deviations between the measured response and the target response, and
adjusting sound using the obtained deviations.

2. The method of claim 1, wherein the response is a frequency response and wherein the target response is a target frequency response.

3. The method of claim 2, wherein measuring the frequency response comprises measuring the frequency response at least of one of
A) the ear's pinna;
B) the ear's concha;
C) the ear canal; and
D) the ear cochlea.

4. The method of claim 1, wherein measuring the frequency response comprises generating at least one of
A) a reference tone;
B) a burst of white noise;
C) a maximum length sequence (MLS);
D) a pulse; and
E) pink noise,
or a derivative thereof.

5. The method of claim 1, wherein measuring a response of a human's ear to a test signal comprises measuring response for sounds, which are characterized by at least one of
A) pitch,
B) loudness, and
C) timbre.

6. The method of claim 1, further comprising translating the measured response and the target response into a frequency spectrum.

7. The method of claim 1, wherein the response is an auditory brainstem response and wherein the target response is a target auditory brainstem response.

8. The method of claim 1, wherein the target response characterizes a required response for a target type of sound.

9. The method of claim 1, wherein the target response characterizes a required response for a target type of environment.

10. The method of claim 1, wherein adjusting the sound using the obtained deviations comprises tone control.

11. The method of claim 1, wherein adjusting the sound using the obtained deviations comprises equalizing the sound.

12. The method of claim 1, wherein measuring a response of a human's ear to a test signal comprises measuring the response for each ear individually.

13. The method of claim 1, wherein adjusting the sound using the obtained deviations comprises filtering the sound in real-time.

14. The method of claim 1, wherein comparing the measured response with a target response comprises translating the response using at least one of
A) a default value,
B) an interpolated value, and
C) an extrapolated value,
where no evaluable response is measured,

15. A unit for adjusting sound comprising:
a test signal generator for generating a test signal,
a response signal sensor arranged for measuring a response of a human's ear to the test signal,
a comparator arranged for comparing the measured response with a target response, and for obtaining deviations between the measured response and the target response, and
an adjusting unit arranged for adjusting sound using the obtained deviations.

16. The unit of claim 15, wherein the test signal generator comprises at least one loudspeaker for playing back the test signal.

17. The unit of claim 15, wherein the response signal sensor comprises at least one microphone for receiving the human's ear response to the test signal.

18. The unit of claim 15, wherein the comparator is further arranged to translate the measured response and the target response into a frequency spectrum.

19. The unit of claim 15, wherein the response signal sensor comprises an auditory brainstem response measuring unit.

20. The unit of claim 15, wherein the adjusting unit comprises at least one of
A) a tone controller;
B) an equalizer;
C) a pitch resolution controller to enable recognition of absolute pitches;
D) a loudness controller for equal loudness curves; and
E) a quality or timbre controller to enable recognition of harmonic content, attack and decay,
and vibrato of a musical instruments.

21. An electronic device comprising a unit of claim 15.

22. A mobile communication device comprising a unit of claim 15.

23. A software program product, in which a software code for adjusting sound is stored, said software code realizing the following steps when being executed by a processing unit of an electronic device:
measuring a response of a human's ear to a test signal,
comparing the measured response with a target response,
obtaining deviations between the measured response and the target response, and
adjusting sound using the obtained deviations.
